(19) United States
(12) Patent Application Publication
(10) Pub. No.: US 2009/0037302 A1
(43) Pub. Date: Feb. 5, 2009

(54) PROGRAMMATICALLY SCHEDULED VERIFICATION

(75) Inventor: Glenn B. Schulz, Lannon, WI (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 11/535,554

(22) Filed: Sep. 27, 2006

(51) Int. Cl. G06Q 10/00; G06F 17/30

(52) U.S. Cl. 705/30; 705/1; 707/104.1; 707/E17.044

(57) ABSTRACT

The claimed subject matter provides a system and/or method that facilitates verifying an asset within an industrial environment based upon a programmatically defined state. A sensing component can determine a state of a process that corresponds to a programmatically defined state. A verification component can verify an asset associated with the process upon the sensing component that determines the state of the process.

### TECHNICAL FIELD

The claimed subject matter relates generally to asset verification in a facility and, more particularly, to verifying assets within an industrial facility based on a programmatically defined states.

### BACKGROUND

Due to advances in computing technology, businesses today are able to operate more efficiently when compared to substantially similar businesses only a few years ago. For example, internal networking enables employees of a company to communicate instantaneously by email, quickly transfer data files to disparate employees, manipulate data files, share data relevant to a project to reduce duplications in work product, etc. Furthermore, advancements in technology have enabled factory applications to become partially or completely automated. For instance, operations that once required workers to put themselves proximate to heavy machinery and other various hazardous conditions can now be completed at a safe distance therefrom.

Further, imperfections associated with human action have been minimized through employment of highly precise machines. Many of these factory devices supply data related to manufacturing to databases or web services referencing databases that are accessible by system/process/project managers on a factory floor. For instance, sensors and associated software can detect a number of instances that a particular machine has completed an operation given a defined amount of time. Additionally, data from sensors can be delivered to a processing unit related to system alarms. Thus, a factory automation system can review collected data and automatically and/or semi-automatically schedule maintenance of a device, replacement of a device, and other various procedures that relate to automating a process.

Control of a process is typically effectuated through controlling one or more assets within a facility, wherein assets can include hardware, such as programmable logic controllers, machines, switches, and the like as well as software components, such as certain programs, sub-programs, and the like. The assets themselves are typically associated with an asset management program and/or functionality, which is conventionally associated with tasks such as backing up devices, checking auditing capabilities, archiving data, periodic scanning of assets to ensure that they are operating without problems, monitoring data entering and leaving a plant floor, and the like.

Verification of such assets within a facility can be an overwhelming task based on the vast amount of assets, which can lead to inefficient, costly, meticulous, and mundane procedures that do not completely ensure asset accuracy. Typically, assets were verified based on a time schedule and/or cycle. For example, based on a periodic amount of time, the assets within a facility would be verified. By closely relating verification procedures with time, the facility has little control over the verification of assets. Pursuant to one particular example, customers may wish to have more control over batch applications and asset verifications associated therewith rather than simply basing verification on a periodic and/or time schedule. There is no convenient mechanism for asset verification based on a characteristic other than time.

### SUMMARY

The following presents a simplified summary of the claimed subject matter in order to provide a basic understanding of some aspects described herein. This summary is not an extensive overview, and is not intended to identify key/critical elements or to delineate the scope of the claimed subject matter. Its sole purpose is to present some concepts in a simplified form as a prelude to the more detailed description that is presented later.

The subject innovation relates to systems and/or methods that facilitate verifying an asset within an industrial environment based upon a programmatically defined state. A sensing component can ascertain a state of a process that corresponds to a programmatically defined process state, wherein a verification component can utilize such determination as a trigger event to initiate a validation and/or verification of assets related to the process. In other words, the verification of assets can be based on and/or triggered by a programmatically defined state rather than the conventional and inefficient characteristic of time and/or a timed schedule. The industrial environment can include various assets that can be verified and/or quality ensured, wherein at least two assets can be hierarchically arranged, such as one that is utilized to manufacture consumables, textiles, automobiles, or any other suitable industrial environment. Moreover, the asset can be a physical device, such as a programmable logic controller, a pump, a press, a valve, a drain, a heater, a cooler, a switch, a sensor, a conveyor, and/or a portion thereof, as well as software, firmware, etc.

In another aspect in accordance with the subject innovation, the subject innovation can include a data repository that can retain the hierarchical representation of assets. The data repository can be a single data repository and/or can be a distributed data store. The hierarchy can be based at least in part upon the physical location of devices (e.g., a region of a factory can have several defined sub-regions, which in turn can comprise sub-regions), standards associated with industry, such as ISA, S95, ISA S88, and the like, proprietary hierarchy that is provided by an enterprise, or any other suitable hierarchy. In addition, the claimed subject matter can include a correcting component that can correct any defects and/or errors associated with assets determined by the verification component. In particular, the correcting component can repair any invalidation and/or errors associated with the validation procedure on assets based on a trigger implemented by the verification component. For instance, the correcting component can provide automatic repairing techniques, manual repairing techniques, and/or any combination thereof.

In accordance with another aspect of the innovation described herein, the verification component can utilize a detection component that can detect any alterations associated with assets within the industrial environment. In particular, the detection component can be communicatively coupled to the industrial environment and poll the assets to ascertain if any assets have been added, removed, changed, and/or any combination thereof. Moreover, the subject innovation can further include an updating component that can update the hierarchical representation of assets in accordance with any alterations detected by the detection component. By providing detection and updating of any alterations associated with the assets within the industrial environment, the verification component can provide accurate and up-to-date verifications to a user and/or entity.

In accordance with an aspect of the claimed subject matter, the subject innovation can include a rollback component that can provide rollback techniques for the process in order to ensure the process does not execute with errors and/or deficiencies detected by the verification component. In other words, the rollback component can allow the process to pick up where it left off in the case of the process having an error, an interruption, and/or a deficiency involved with assets. In accordance with another aspect of the claimed subject matter, the subject innovation can further include an alert component that can provide various alerts in relation to verification status of the assets within the industrial environment, the hierarchical representation of assets, and/or any combination thereof. The alert component can provide audio, visual, device/process manipulation, text, digital signal, communication, etc. alerts that indicate status to a user and/or entity (e.g., computer, device, etc.). In other aspects of the claimed subject matter, methods are provided that facilitates employing verifying an asset within an industrial environment based upon a programmatically defined state.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed and such subject matter is intended to include all such aspects and their equivalents. Other advantages and novel features will become apparent from the following detailed description of the invention when considered in conjunction with the drawings.

### BRIEF DESCRIPTION OF THE DRAWINGS

FIG. 1 illustrates a block diagram of an exemplary system that facilitates verifying an asset within an industrial environment based upon a programmatically defined state.

FIG. 2 illustrates a block diagram of an exemplary system that facilitates employing a verification schedule for hierarchically represented assets based on a programmatically defined state related to a process.

FIG. 3 illustrates a block diagram of an exemplary system that facilitates ensuring the validation of assets within an industrial environment that can be updated in real-time.

FIG. 4 illustrates a block diagram of an exemplary system that facilitates verifying assets based on a programmatically defined state of a process and providing rollback techniques.

FIG. 5 illustrates a block diagram of an exemplary system that facilitates verifying an asset within an industrial environment based upon a programmatically defined state.

FIG. 6 illustrates a block diagram of an exemplary data structure that represents a hierarchical structure of an industrial automation system.

FIG. 7 illustrates a block diagram of an exemplary system that facilitates verifying an asset within an industrial environment based upon a programmatically defined state associated with a process.

FIG. 8 illustrates an exemplary methodology for verifying an asset within an industrial environment based upon a programmatically defined state.

FIG. 9 illustrates an exemplary methodology that facilitates ensuring the validation of assets within an industrial environment that can be updated in real-time.

FIG. 10 is an exemplary computing environment that can be utilized in connection with the claimed subject matter.

FIG. 11 is an exemplary networking environment that can be utilized in connection with the claimed subject matter.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such matter can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

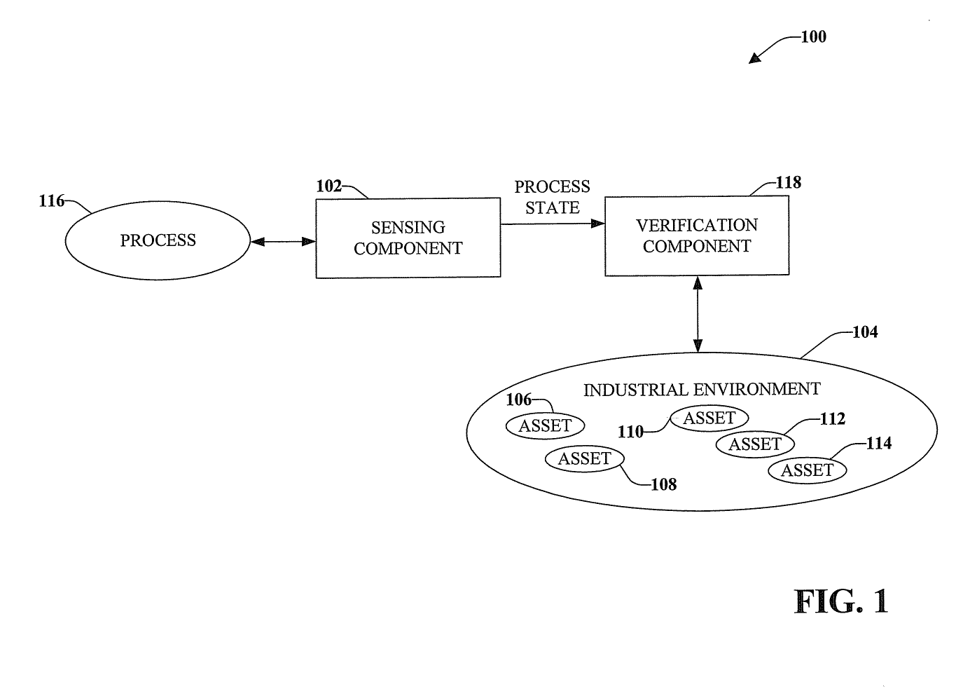

Now referring to the drawings, FIG. 1 illustrates a system 100 that facilitates verifying an asset within an industrial environment based upon a programmatically defined state. The system 100 can include a sensing component 102 that can ascertain a state of a process 116 corresponding to a programmatically defined process state. Based at least in part upon the programmatically defined process state determined by the sensing component 102, verification of an asset within an industrial environment 104 can be employed by a verification component 118, wherein such asset can be associated with the process 116. The industrial environment 104 can include various assets 106-114 that can be verified and/or quality ensured, wherein at least two assets can be hierarchically arranged, such as one that is utilized to manufacture consumables, textiles, automobiles, or any other suitable industrial environment. To illustrate another example hierarchy, the asset 110 may be a programmable logic controller, while the assets 112 and 114 may be different control programs effectuated by the asset 110. Thus, the hierarchical representation of assets may be a combination of physical devices and software. For instance, an asset can be a physical device, such as a programmable logic controller, a pump, a press, a valve, a drain, a heater, a cooler, a switch, a sensor, a conveyor, and/or a portion thereof, as well as software, firmware, etc.

Conventionally, verification of assets was solely based on time and/or a periodic scheduling which limited control over various processes and/or included assets. On the contrary, by utilizing the sensing component 102 to ascertain a programmatically defined state, the verification component 118 can verify the assets 106-114 within the industrial environment 104 based upon a criteria associated with the programmatically defined state. Additionally, the verification component 118 can provide at least one of validating an asset, backing up an asset, archiving data associated with an asset, updating an asset with new or additional software or firmware, and the like. For example, with respect to expensive batch applications, users and/or customers may wish to have more control over the verification of assets associated with a batch other than a simple schedule time and/or time-based verification procedure. Thus, the verification component 118 can utilize a trigger to initiate a verification of assets 106-114 within the industrial environment 104. The trigger can be, for instance, an event and/or criteria associated with, in general, a state of the process 116, and in particular, a programmatically defined state of the process 116. For instance, the trigger can be an initiation of a batch such that verification procedures and/or techniques can be undertaken with respect to assets associated with the batch. In another example, an electronic signature can be required prior to enabling generation of the batch (thus more efficiently associated liability with an improperly produced batch).

In accordance with one aspect of the claimed subject matter, the verification and/or validation of assets can be based at least in part upon a particular point in a sequence of events associated with the process 116. The process 116 can include various states related thereto that allow the verification component 118 to initiate verification and/or validation based on a state and/or programmatically defined state ascertained by the sensing component 102. In particular, the trigger for initiating validation can be the specific collection of data, request for data, transmission of data, update of data, removal of data, and/or any combination thereof. In other words, upon the sensing component 102 determining the trigger (e.g., state of a process, programmatically defined state, etc.) has occurred, the verification component 118 can employ verification and/or validation techniques and/or mechanisms to ensure quality of the system 100.

In another implementation of the subject invention, the system 100 can initiate corrective procedures in order to reverse any errors detected by the verification component 118. Moreover, in addition to correcting detected errors, the system 100 can include at least one of the following: various logs to track data associated with verification, alerts to inform users and/or entities of an error related to verification, rollback techniques that allow stepping backwards through a process to allow corrective measures to be implemented, security techniques to ensure protected and/or secure verification triggers and/or authorization mechanisms to be in place for verification, etc.

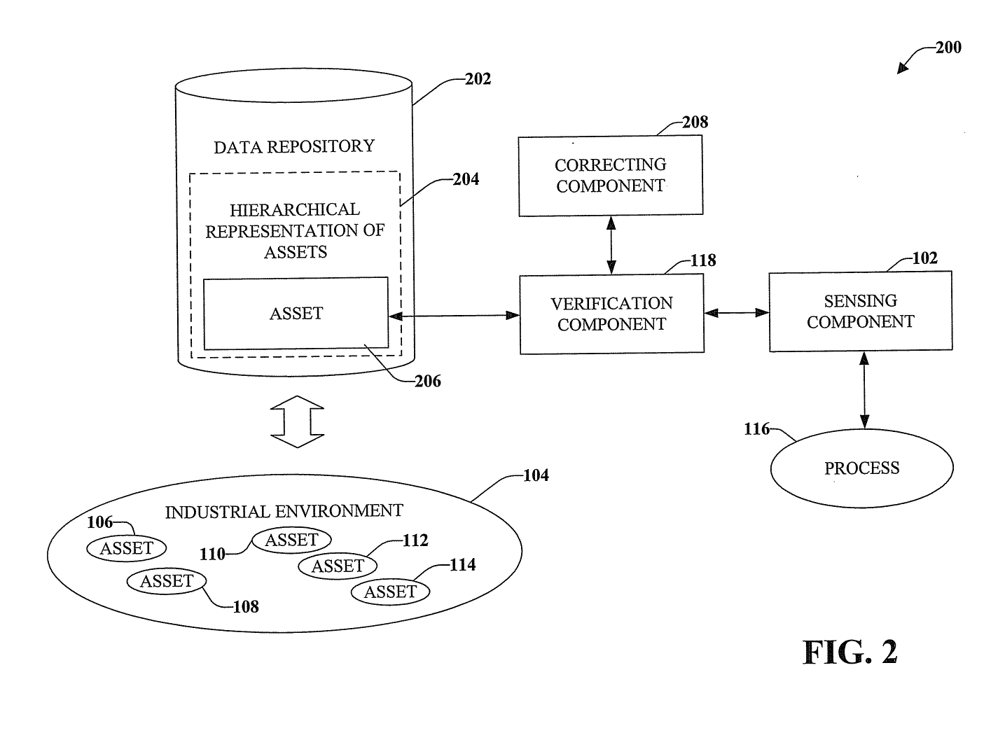

FIG. 2 illustrates a system 200 that facilitates employing a verification schedule for hierarchically represented assets based on a programmatically defined state related to a process. The system 200 can include the sensing component 102 that can determine a programmatically defined state of the process 116, wherein any aspect and/or state of the process 116 can be a trigger to initiate a verification and/or validation of the assets 106-114 employed by the verification component 118. It is to be appreciated that the assets 106-114 can be related to the process 116. The system 200 can further include a data repository 202 that can retain a hierarchical representation of assets 204. The data repository 202 can be a single data repository and/or can be a distributed data store. The hierarchy can be based at least in part upon the physical location of devices (e.g., a region of a factory can have several defined sub-regions, which in turn can comprise sub-regions), standards associated with industry, such as ISA, S95, ISA S88, and the like, proprietary hierarchy that is provided by an enterprise, or any other suitable hierarchy. For instance, a top portion of the hierarchy may be a plant, and a sub-level of the plant may be programmable logic controllers utilized within the plant, and a sub-level of the programmable logic controllers can be devices controlled by such controllers. It is understood that this is but one example of a hierarchy, and is for illustrative purposes only. Thus, the verification of assets can be the validation and/or verification of assets 106-114 within the industrial environment 104, the hierarchical representation of assets 204, and/or any combination thereof.

The system can also include a correcting component 208 that can correct any defects and/or errors associated with assets determined by the verification component 118. In particular, the verification component 118 can initiate a validation procedure on assets based upon a trigger (e.g., state of the process 116, programmatically defined state, etc.), wherein any invalidation and/or errors associated with the assets can be repaired by the correcting component 108. For example, the correcting component 208 can provide automatic repairing techniques, manual repairing techniques, and/or any combination thereof. In one particular example, the correcting component 208 can utilize intelligence to infer and/or provide automatic corrections based on repair and/or error historical data in relation to what manual repair technique was implemented.

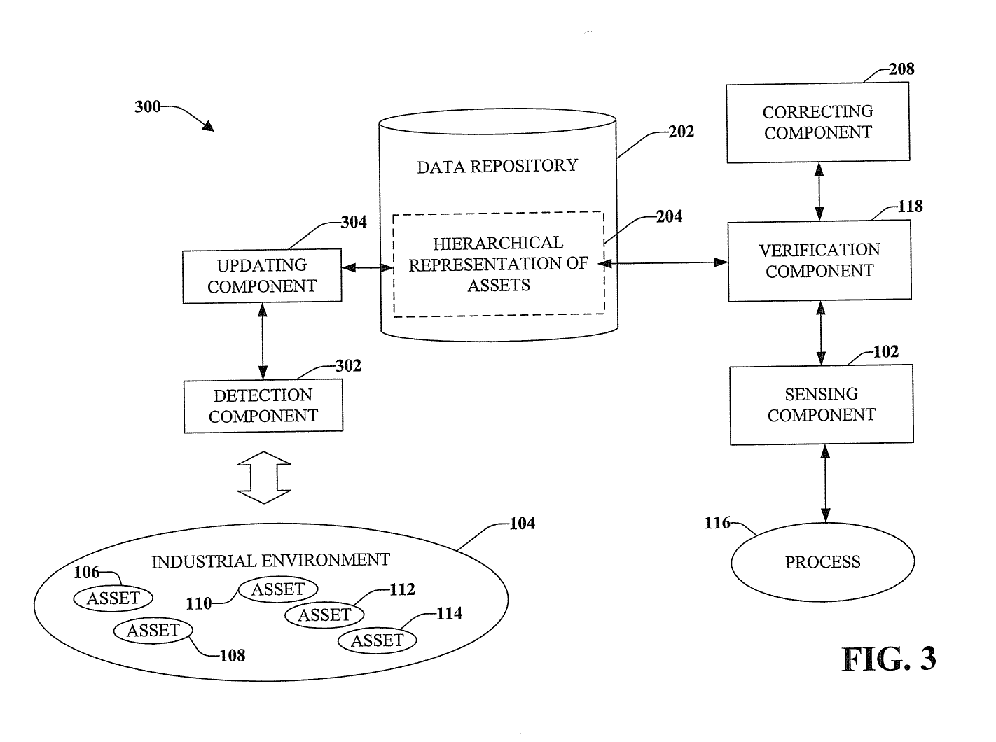

FIG. 3 illustrates a system 300 that facilitates ensuring the validation of assets within an industrial environment that can be updated in real-time. The system 300 can include a detection component 302 that can be communicatively coupled to the industrial environment 104 and, in turn, the assets 106-114. For example, the assets 106-114 can be communicatively coupled by way of an intranet or other suitable network. The detection component 302 can ascertain when an asset has been added to the industrial environment 104, removed from the industrial environment 104, updated within the industrial environment 104, and/or any combination thereof. Any changes associated with the assets 106-114 can be communicated to verification component 118 to allow for real-time and up-to-date additions, removals, updates, changes, and the like to ensure quality validation techniques and/or mechanisms associated with the industrial environment 104, respective assets 106-114, the hierarchical representation of assets 204, and/or any combination thereof. Pursuant to an example, the detection component 302 can poll a network to determine whether any alterations have been made with respect to assets resident upon the network. In another example, an asset may have sufficient intelligence to initiate a message to the detection component 302, wherein such message can include a type or identity of the asset, location upon a network of the asset, associated assets, etc. Still further, an asset can indicate to the detection component 302 a type of update associated with the asset.

Once an alteration occurs with respect to one or more assets within the industrial environment 104 and such alteration has been detected by the detection component 302, an updating component 304 can update the hierarchical representation of assets 204 within the data repository 202. For instance, if an asset is added to the industrial environment 104, the updating component 304 can ascertain a type of such asset, location of the asset, and the like based upon detections made by the detection component 302. The updating component 304 can then review the structure of the hierarchical representation of assets 204 (e.g., to determine whether it is based on location, functionality of devices, . . . ). Once this review has been undertaken, the updating component 304 can intelligently and automatically update the hierarchical representation of assets 204. For instance, if an asset is added to the industrial environment 104, the updating component 304 can add the asset in an appropriate position within the hierarchical representation of assets 204.

A graphical user interface component (not shown) can utilize various graphics and/or alerts to indicate updates and/or changes associated with the assets 106-114 within the industrial environment 104. In particular, during the verification procedure based on a trigger and/or upon the detection of an alteration of at least one asset within the industrial environment 104, the graphical user interface component can indicate such detection with, for example, an alert, an audible alert, a graphical icon, a graphic, a textual document, an email, a text, etc. Moreover, any updates associated with the hierarchical representation of assets 204 can be indicated via the graphical user interface component utilizing, for instance, an alert, an audible alert, a graphical icon, a graphic, a textual document, an email, a text, etc.

The updating component 304 can also be employed to associate updated functionality with assets represented within the hierarchical representation of assets 204. Pursuant to an example, particular verification functionality may become available with respect to certain PLCs. The updating component can update the functionality with respect to such PLCs that are represented within the hierarchical representation of assets 104 and can allow the subsequent and/or real-time update to a user and/or entity via the graphical user interface component 102. Therefore, if a representation of such asset is selected by a user, the new or enhanced functionality will also be displayed. According to an example, the updating component 304 can be connected to a network (e.g., the Internet) and can receive functionality updates through web services or the like.

In addition, the system 300 can contain an instance of an asset that does not include sufficient intelligence to inform the updating component 304 of identify when such asset is coupled to a network. It may be known, however, how particular assets react to certain stimulation. Accordingly, when the asset is added to a network, a stimulating component (not shown) can provide the asset with certain electrical stimuli. The asset can be associated with, for example, a fingerprint and/or any other suitable identification data (e.g., radio frequency identification, bar code, serial number, etc.) that can be utilized to identify the asset, wherein the identification data makes itself known when provided with particular stimuli. Pursuant to one example, the stimulating component can be an electrical power source which provides certain electrical pulses to the asset to determine the identification data. For instance, the asset can react in a certain manner to particular stimuli, thus illuminating the identification data to be recognized by, for instance, a recognition component (not shown).

The recognition component can be trained to monitor responses of the asset with respect to certain stimuli provided by the stimulating component. Thus, the recognition component can determine an identity of the asset (and possibly relationships to other assets) by discerning the identification data associated with such asset. The updating component can thereafter utilize this information as well as other available information to update the hierarchical representation of assets 204. Thus, a representation of the asset can be placed appropriately within the hierarchical representation of assets 204 by the updating component.

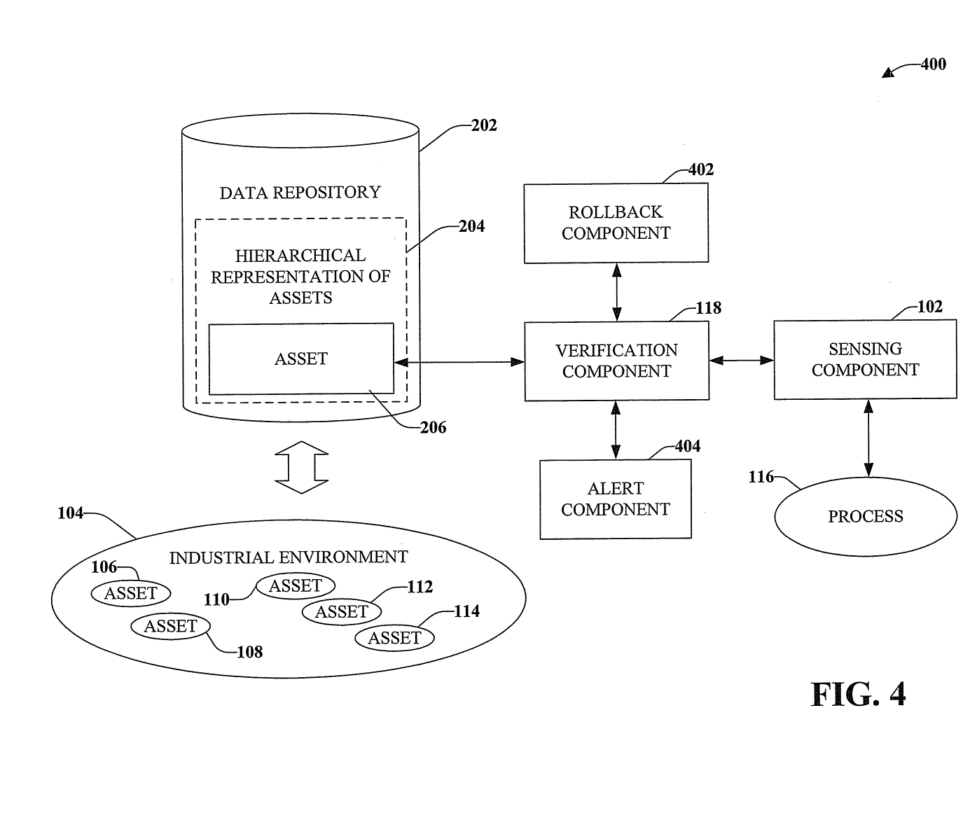

FIG. 4 illustrates a system 400 that facilitates verifying assets based on a programmatically defined state of a process and providing rollback techniques. The system 400 can utilize a rollback component 402 that can provide rollback mechanisms to correct defects and/or errors associated with assets 106-114 and/or the hierarchical representation of assets 204. In particular, the rollback component 402 can allow the rolling of the process 116 back to a previous point in the process 116 to utilize data when an error and/or interruption occurs in relation to assets. For example, the error and/or interruption can be a detected error in assets, a power outage, a reboot, an error, a corruption, a crash, a manual restart, a bug, an inconsistent asset detection, etc. In other words, the rollback component 402 can allow the process 116 to pick up where it left off in the case of the process 116 having an error, an interruption, and/or a deficiency involved with assets (e.g., detected by the verification component 118). Thus, the process 116 can be placed back to a point before the error, asset verification error detection, and the like occurred by utilizing the rollback component 402.

The system 400 can further include an alert component 404 that can provide various alerts in relation to verification status of the assets 106-114 within the industrial environment 104, the hierarchical representation of assets 204, and/or any combination thereof. For instance, an alert can be an indication of verification, an indication of the assets not being verified, an error associated therewith, a corruption of the assets, an error related to the process 116, etc. The alert component 404 can provide audio, visual, device/process manipulation, text, digital signal, communication, etc. alerts that indicate status of the system 400 to a user and/or entity (e.g., computer, device, etc.). In one particular example, the alert component 404 can sound an audible alarm to inform users when assets fail validation initiated by the verification component 118 and can manipulate any related process(es) 116 associated therewith.

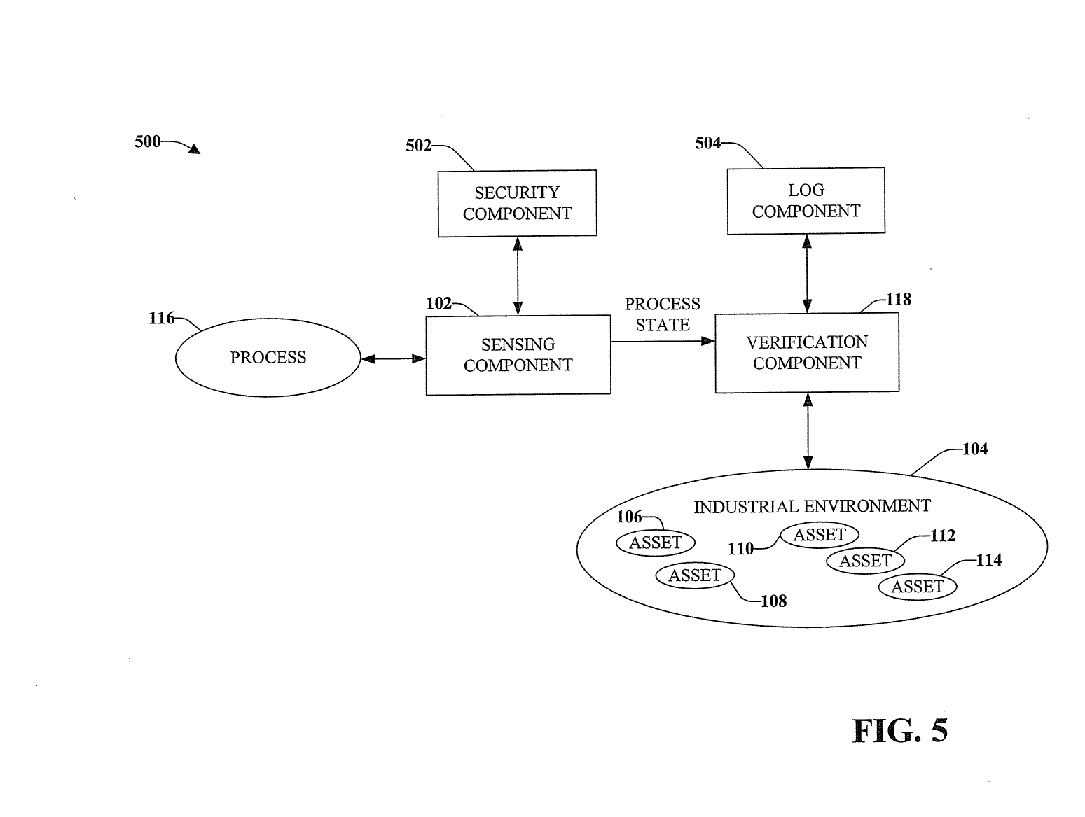

FIG. 5 illustrates a system 500 that facilitates verifying an asset within an industrial environment based upon a programmatically defined state. The system 500 can include a security component 502 that can ascertain which assets and/or processes related thereto a user is authorized to verify and/or manipulate. In accordance with one example, a user may only be authorized to verify a certain asset, while not authorized to verify a disparate asset. In addition, the user may be able to manipulate a certain process, while not authorized to verify a disparate asset. The security component 502 can determine identity of a user by analyzing, for instance, usernames, passwords, personal identification numbers, personal status, management positions, occupation hierarchy, and the like. Furthermore, the security component 502 can determine a user's identity by analyzing biometric indicia, such as voice recognition, fingerprint analysis, retina analysis, etc.

Still further, the security component 502 can perform granular security with respect to a user and/or an asset. Pursuant to one example, a user's rights with respect to a particular asset can change as time alters. For instance, certain management functionality associated with an asset requested by a user can be accessible by the user during a first shift but not accessible to the user during a second shift. Additionally, the security component 502 can provide different measures of security given different states of an asset and/or process. Therefore, for example, a user may have rights with respect to verification when an asset and/or process is in a first state but may have different rights with respect to the same verification when the asset and/or process are in a second state. Once a user has been identified and rights associated with such user have been determined, the user can select verification associated with an asset and/or process within the industrial environment 104.

The system 500 can further include a log component 504 that can work in conjunction with the verification component 118, the sensing component 102, and/or any combination thereof in order to track any verification data and/or sensing data related to the system 500. For instance, the log component 504 can track and/or record data related to the various assets verified based upon the particular programmatically defined state, the determine process state that a particular asset was to be verified, the accuracy of the verification and/or validation, etc. Moreover, the log component 504 can track various user data in connection with any security and/or authorization utilized with the system 500. For example, a particular user can initiate a manual correction for a detected error related to an asset. In such a case, the log component 504 can track which particular user initiated the specific correction.

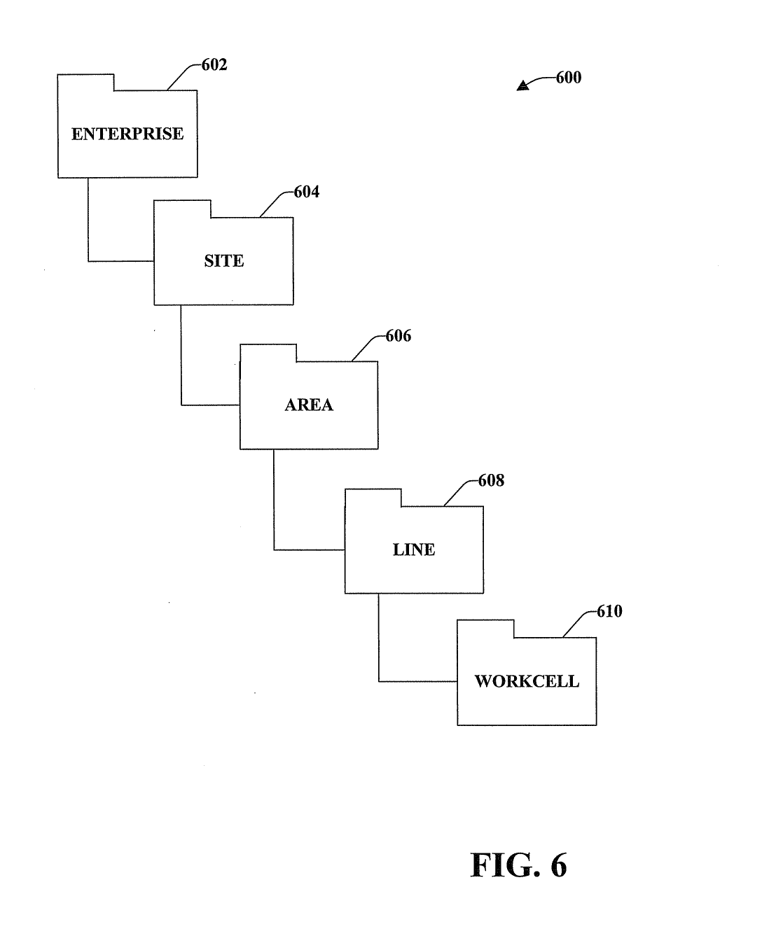

Referring now to FIG. 6, an exemplary hierarchical structure 600 which can be utilized in connection with the hierarchically structured data model (e.g., hierarchical representation of assets) alluded to herein is illustrated. For example, the data model can facilitate nested structures, thereby mitigating deficiencies associated with data models that employ flat namespaces. The structure 600 includes an enterprise level 602, where a particular enterprise can be represented within data structured in accordance with a hierarchical data model. Beneath the enterprise level 602 can be a site level 604, so that a particular factory (site) within an enterprise can be represented within a data packet. Beneath the site level 604 an area level 606 can exist, which specifies an area within the factory that relates to the data. A line level 608 can lie beneath the area level 606, wherein the line level 608 is indicative of a line associated with particular data. Beneath the line level 608 a workcell level 610 can exist, thereby indicating a workcell associated with the data. Utilizing a nested, hierarchical data model, PLCs can become more aware of data associated therewith. Furthermore, the hierarchy 600 can be customized by an owner of such hierarchy. For instance, more granular objects/levels can be defined within the hierarchy 600 in relation to the various assets associated therewith.

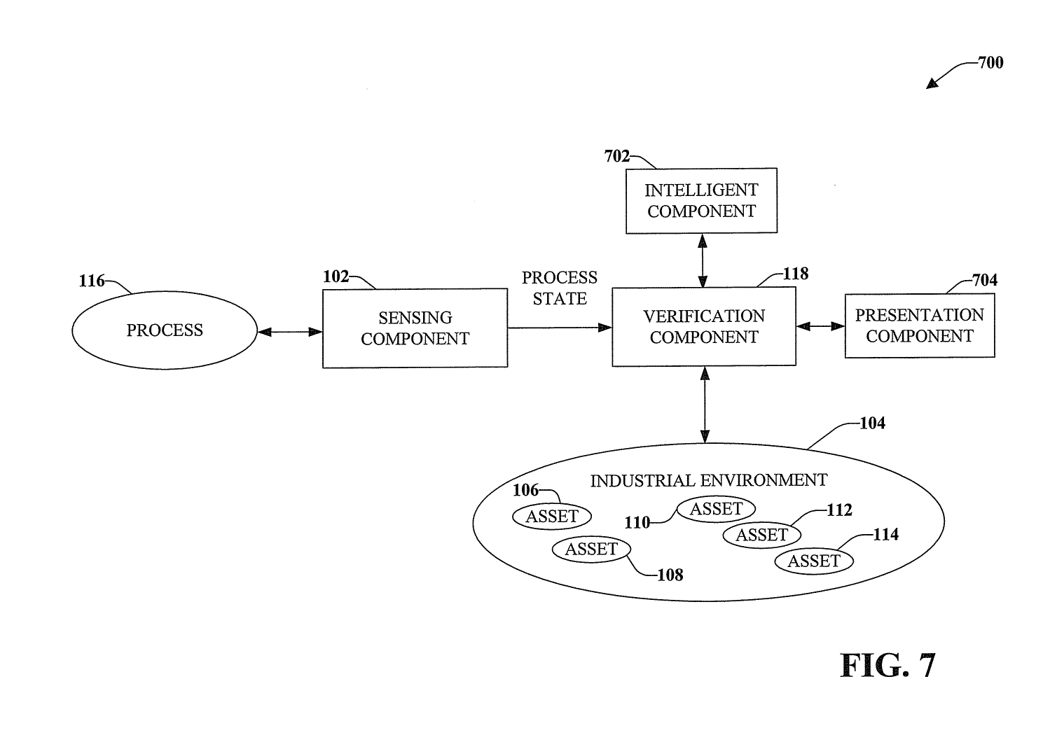

FIG. 7 illustrates a system 700 that employs intelligence to facilitate verifying an asset within an industrial environment based upon a programmatically defined state associated with a process. The system 700 can include the sensing component 102, an industrial environment 104 with assets 106-114, the process 116, and the verification component 118 that can all be substantially similar to respective components, environments, assets, and processes described in previous figures. The system 700 further includes an intelligent component 702. The intelligent component 702 can be utilized by the sensing component 102 and/or the verification component 118 to facilitate determining a programmatically defined state to initiate verification of assets within the industrial environment 104. For example, the intelligent component 702 can infer corrective measures for invalid assets, verification procedures, programmatically defined states, state of processes, changes in assets, assets added, assets removed, asset locations, security settings, updates, detection of changes with an asset, asset identification data, hierarchical representation of assets within the industrial environment, user settings, profiles, etc.

It is to be understood that the intelligent component 702 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The presentation component 704 can provide various types of user interfaces to facilitate interaction between a user and any component coupled to the verification component 118. As depicted, the presentation component 704 is a separate entity that can be utilized with verification component 118. However, it is to be appreciated that the presentation component 704 and/or similar view components can be incorporated into the verification component 118 and/or a stand-alone unit. The presentation component 704 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to the verification component 118.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

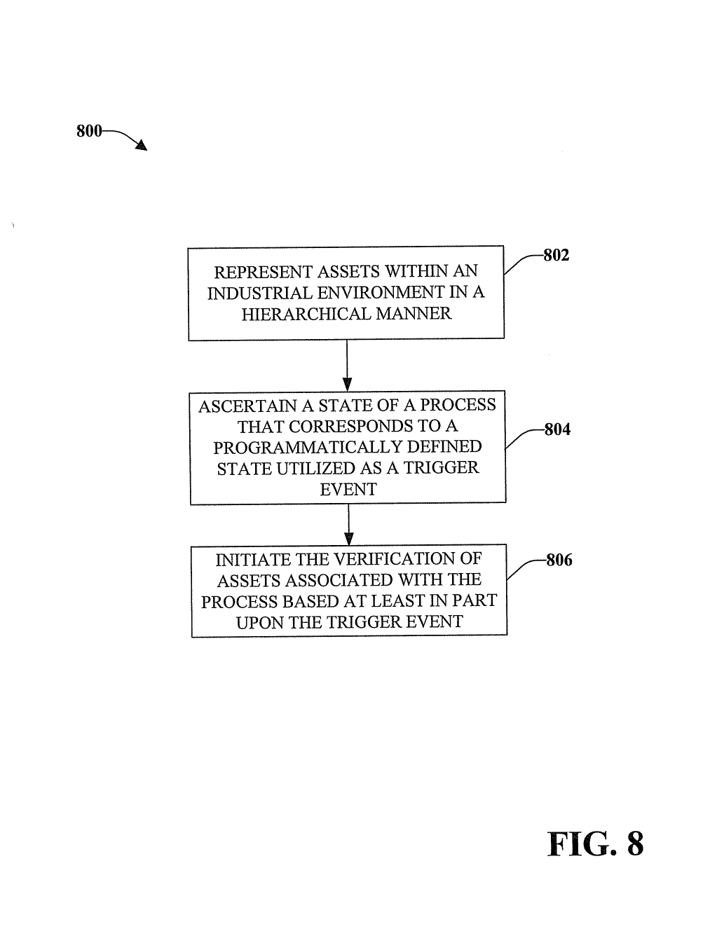

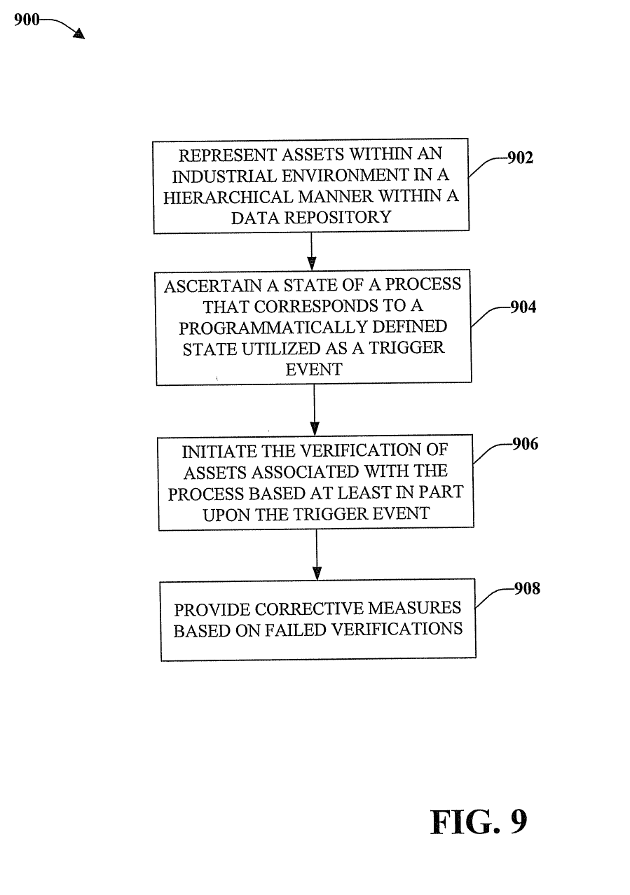

Referring to FIGS. 8-9, methodologies in accordance with various aspects of the claimed subject matter are illustrated. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 illustrates a methodology 800 for verifying an asset within an industrial environment based upon a programmatically defined state. At reference numeral 802, assets within an industrial environment can be represented in a hierarchical manner based upon a characteristic. For instance, an asset can be a physical device, such as a programmable logic controller, a pump, a press, a valve, a drain, a heater, a cooler, a switch, a sensor, a conveyor, and/or a portion thereof, as well as software, firmware, etc. The industrial environment can include various assets wherein at least two assets can be hierarchically arranged, such as one that is utilized to manufacture consumables, textiles, automobiles, or any other suitable industrial environment. To illustrate another example hierarchy, the asset may be a programmable logic controller, while the assets may be different control programs effectuated by the asset. Thus, the hierarchical representation of assets may be a combination of physical devices and software.

In addition, the hierarchy can be based at least in part upon a characteristic such as, but not limited to, the physical location of devices (e.g., a region of a factory can have several defined sub-regions, which in turn can comprise sub-regions), standards associated with industry, such as ISA, S95, ISA S88, and the like, proprietary hierarchy that is provided by an enterprise, or any other suitable hierarchy. For instance, a top portion of the hierarchy may be a plant, and a sub-level of the plant may be programmable logic controllers utilized within the plant, and a sub-level of the programmable logic controllers can be devices controlled by such controllers. It is understood that this is but one example of a hierarchy, and is for illustrative purposes only. Moreover, such physical assets and/or hierarchically represented assets can be associated with a process.

At reference numeral 804, a state of the process that corresponds to a programmatically defined state can be ascertained and utilized as a trigger event. For instance, with respect to expensive batch applications, customers may wish to have more control of verification of assets associated with the batch than simply a scheduled time. The trigger event, such as initiation of a batch can be utilized to trigger a verification procedure with respect to assets associated with the batch. It is to be appreciated that any suitable state of a process and/or a programmatically defined state of the process can be utilized as a trigger event. At reference numeral 806, the verification of assets associated to the process can be initiated based at least in part upon the trigger event. Moreover, the trigger event can be selected and/or determined by a user, automatically, and/or any combination thereof. For example, if upon the initiation of the trigger event (e.g., causing the validation procedure to be executed), the verification of the assets are suitable, the process can continue as usual. Yet, if the verification of the assets fails, the process can be adjusted (e.g., settings, configurations, reset, halted, restart, etc.).

FIG. 9 illustrates a methodology 900 that facilitates ensuring the validation of assets within an industrial environment that can be updated in real-time. At reference numeral 902, two or more assets within an industrial environment can be hierarchically structured in a data repository. The data repository that can retain a hierarchical representation of assets and can be a single data repository and/or can be a distributed data store. The hierarchy can be based at least in part upon the physical location of devices (e.g., a region of a factory can have several defined sub-regions, which in turn can comprise sub-regions), standards associated with industry, such as ISA, S95, ISA S88, and the like, proprietary hierarchy that is provided by an enterprise, or any other suitable hierarchy. For instance, a top portion of the hierarchy may be a plant, and a sub-level of the plant may be programmable logic controllers utilized within the plant, and a sub-level of the programmable logic controllers can be devices controlled by such controllers. It is understood that this is but one example of a hierarchy, and is for illustrative purposes only.

At reference numeral 904, a state of a process (e.g., relating to at least one asset) can be determined, wherein such state can correspond to a programmatically defined state. In particular, the determined state and/or programmatically defined state can be implemented as a trigger event. At reference numeral 906, the trigger event can initiate the verification of assets associated with the process. By verifying the assets based on the trigger event, more control over assets and validation associated therewith can be provided. In other words, rather than utilizing time and/or a time schedule as the factor for verifying and/or validating assets, a state and/or programmatically defined state of a process can dictate when assets get verified which can be a more useful and granular approach in comparison to conventional techniques.

At reference numeral 906, corrective measures can be implemented based on the verification of the assets utilizing the trigger event. For instance, the corrective measure can repair any invalidation and/or errors associated with the assets. For example, the corrective measures can provide automatic repairing techniques, manual repairing techniques, and/or any combination thereof. In another example, the corrective measures can include rollback techniques that allow the process (e.g., associated with the assets that are to be verified) to be placed at an earlier point in the process before the failure was detected. In other words, the process can be placed in a state prior to the error allowing the process to continue with validated and/or verified assets. Moreover, it is to be appreciated that various security, logging, alerting, updating, and/or detection techniques can be employed with the subject innovation.

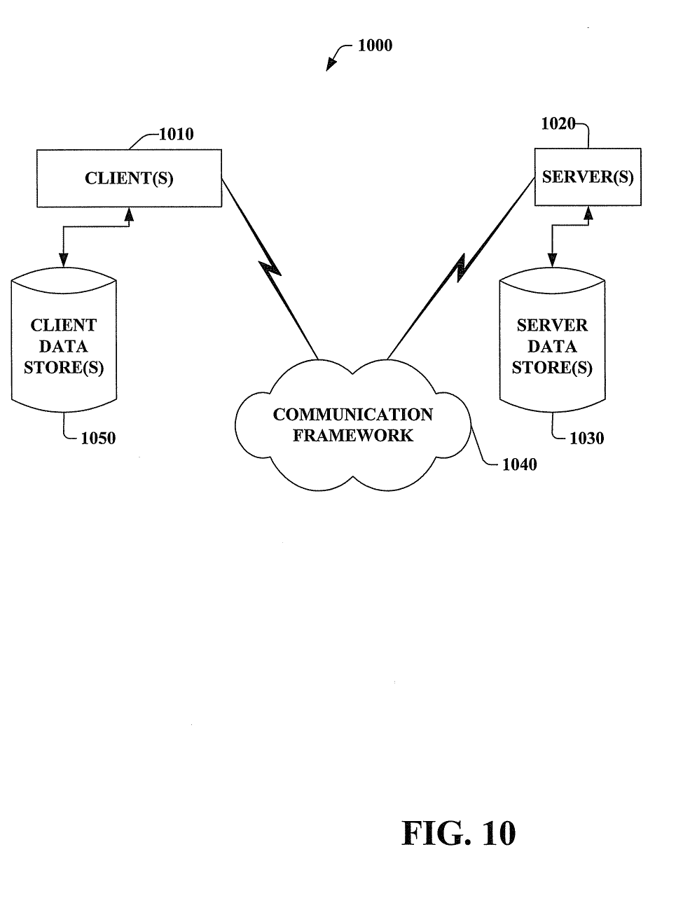

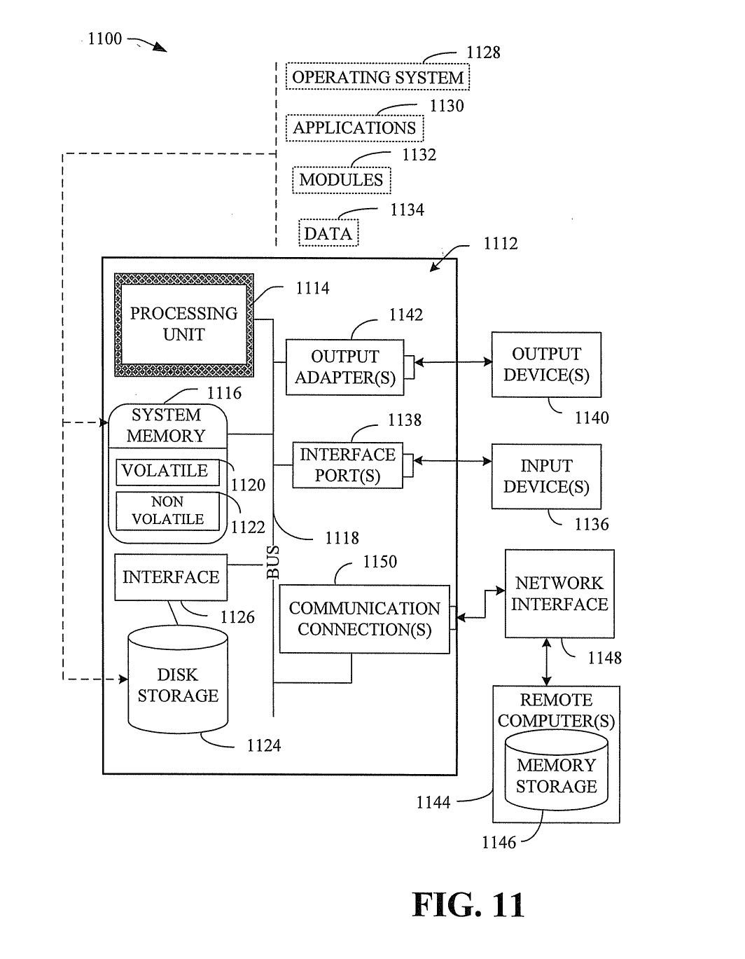

In order to provide additional context for implementing various aspects of the claimed subject matter, FIGS. 10-11 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 10 is a schematic block diagram of a sample-computing environment 1000 with which the claimed subject matter can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

With reference to FIG. 11, an exemplary environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates verification of one or more assets, comprising:
a sensing component that determines that a state of a process corresponds to a programmatically defined state; and
a verification component that verifies an asset associated with the process upon the sensing component determining the state of the process.

2. The system of claim 1, the asset is hierarchically represented based at least in part upon a physical location of the asset within the industrial environment.

3. The system of claim 2, the hierarchical representation of assets is based at least in part upon an industry standard which can be at least one of ISA, S95, ISA, and S88.

4. The system of claim 2, the hierarchical representation of assets is based at least in part upon a proprietary hierarchy that is provided by an enterprise.

5. The system of claim 2, further comprising a data repository that retains a hierarchical representation of assets within the industrial environment.

6. The system of claim 2, the asset is at least one of a physical device, software, and a firmware.

7. The system of claim 6, the physical device is at least one of a programmable logic controller, a pump, a press, a valve, a drain, a heater, a cooler, a switch, a sensor, and a conveyor.

8. The system of claim 2, the process is associated with the hierarchical representation of assets.

9. The system of claim 8, the verification component verifies the hierarchical representation of assets based at least in part upon the sensing component determining the state of the process.

10. The system of claim 1, further comprising a trigger event that relates to at least one of a particular state of the process and a particular programmatically defined state, wherein the trigger event is pre-determined to initiate verification.

11. The system of claim 1, further comprising a detection component that ascertains at least one of when an asset has been added to the industrial environment, when an asset has been removed from the industrial environment, when an asset has been updated within the industrial environment.

12. The system of claim 11, the asset includes sufficient intelligence to initiate a message to the detection component, wherein such message can include at least one of a type of the asset, an identity of the asset, a location upon a network of the asset, and an associated asset.

13. The system of claim 11, the asset utilizes an identification data to detect and maintain alterations of an asset within the industrial environment.

14. The system of claim 11, further comprising an updating component that updates the hierarchical representation of assets within the data repository based upon an alteration determined by the detection component.

15. The system of claim 1, further comprising a correcting component that repairs a deficiency ascertained by the verification component.

16. The system of claim 15, the correcting component provides at least one of the following: an automatic repair to the deficiency and a manual repair to the deficiency.

17. The system of claim 1, further comprising a rollback component that provides a rollback related to the process upon a deficiency detected during verification.

18. The system of claim 17, the rollback is one of a manual rollback, an automatic rollback, and a combination of a manual rollback and an automatic rollback.

19. The system of claim 1, further comprising a security component that ascertains authorization related to at least one of an asset to request and a functionality to implement via the graphical user interface component

20. The system of claim 1, further comprising an alert component that can provide an alert for at least one of the following: a deficiency ascertained by the verification component; a validation ascertained by the verification component; and any combination of a deficiency and a validation ascertained by the verification component.

21. The system of claim 20, the alert is at least one of an indication of verification, an indication of the assets not being verified, an error associated therewith, a corruption of the assets, an error related to the process, audio alert, a visual alert, a process manipulation alert, a text alert, a digital signal alert, a communication to a user, and a communication to an entity.

22. The system of claim 1, further comprising a log component to track a result associated with at least one of the verification component and the sensing component.

23. The system of claim 22, the log component tracks at least one of a verified asset based upon the programmatically defined state, a process state that an asset was verified, a deficiency associated with the verification, and a valid result from verification.

24. A method that facilitates verification of one or more assets, comprising:
representing an asset within an industrial environment in a hierarchical manner;
ascertaining a state of a process that corresponds to a programmatically defined state utilized as a trigger event; and
initiating verification of the asset associated with the process based at least in part upon the trigger event.

25. The method of claim 24, the hierarchical manner is based at least in part upon a physical location of the asset within the industrial environment.

26. The method of claim 24, the hierarchical manner is based at least in part upon an industry standard which can be at least one of ISA, S95, ISA, and S88.

27. The method of claim 24, the hierarchical manner is based at least in part upon a proprietary hierarchy that is provided by an enterprise.

28. The method of claim 24, the asset is at least one of a physical device, software, and a firmware.

29. The method of claim 28, the physical device is at least one of a programmable logic controller, a pump, a press, a valve, a drain, a heater, a cooler, a switch, a sensor, and a conveyor.

30. The method of claim 24, further comprising:
providing a rollback technique based at least in part upon detection of an error;
initiating an alert based at least in part upon the verification; and
correcting the error detected by the verification.

31. A computer-implemented system that facilitates verification of one or more assets, comprising:
means for determining a state of a process corresponds to a programmatically defined state; and
means for verifying an asset associated with the process upon the determination of the state of the process.
